(19) United States
(12) Patent Application Publication
(10) Pub. No.: US 2006/0128852 A1
(43) Pub. Date: Jun. 15, 2006

(54) Compositions for articles comprising replicated microstructures

(75) Inventors: Dennis Joseph Coyle, Clifton Park, NY (US); Bret Ja Chisholm, Fargo, ND (US); Daniel Robert Olson, Voorheesville, NY (US); Anne Elizabeth Herrmann, Glenview, IL (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/010,667

(22) Filed: Dec. 13, 2004

(51) Int. Cl. B60C 1/00

(52) U.S. Cl. 524/261

(57) ABSTRACT

A curable composition comprising a multifunctional (meth)acrylate, an arylether (meth)acrylate and a surfactant along with optional additives is disclosed. The cured composition displays excellent thermomechanical properties with reduced shrinkage and high refractive index.

### BACKGROUND

The invention relates generally to curable (meth)acrylate compositions and, more specifically ultraviolet (UV) radiation curable (meth)acrylate compositions. The compositions are suitable for optical articles and particularly for light management films.

In backlight computer displays or other display systems, optical films are commonly used to direct light. For example, in backlight displays, light management films use prismatic structures (often referred to as microstructure) to direct light along a viewing axis (i.e., an axis substantially normal to the display). Directing the light enhances the brightness of the display viewed by a user and allows the system to consume less power in creating a desired level of on-axis illumination. Films for turning or directing light can also be used in a wide range of other optical designs, such as for projection displays, traffic signals, and illuminated signs. Ultraviolet radiation curable (meth)acrylate compositions find use in applications such as display systems. Films for light management applications are typically prepared by curing a composition in common molds, such as nickel or nickel/cobalt electroforms, into the requisite shape.

UV-curable formulations tend to stick to common molds used for microreplication. This results in poor replication, roughened surfaces, buckling of the coating, and/or catastrophic loss of adhesion to the carrier film and destruction of the mold. There remains a continuing need for further improvement in the materials used to make them, particularly materials that upon curing possess the combined attributes desired to satisfy the increasingly exacting requirements for light management film applications.

### BRIEF DESCRIPTION

This invention relates to a curable composition, comprising:

(a) at least one silicone containing surfactant wherein the surfactant is present in a range corresponding to from about 0.01 to about 5 weight percent based upon the total weight of the composition;

(b) a multifunctional (meth)acrylate represented by the structure I 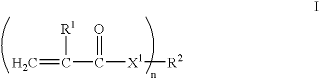
wherein R¹ is hydrogen or methyl; X¹ is O or S; n is 2; and R² is a divalent aromatic radical having structure II: 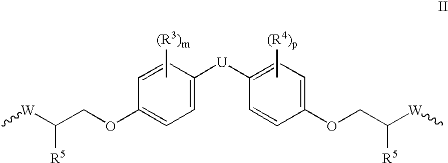
wherein U is a bond, an oxygen atom, a sulfur atom or a selenium atom, an SO₂ group, an SO group, a CO group, a C₁-C₂₀ aliphatic radical, C₃-C₂₀ cycloaliphatic radical, or a C₃-C₂₀ aromatic radical; R³ and R⁴ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; R⁵ is a hydrogen, or a hydroxyl, or a thiol, or an amino group, or a halogen group; W is a bond, or a divalent C₁-C₂₀ aliphatic radical, or a divalent C₃-C₂₀ cycloaliphatic radical, or a divalent C₃-C₂₀ aromatic radical; m and p are integers ranging from 0 to 4; and

(c) an arylether (meth)acrylate monomer having structure III 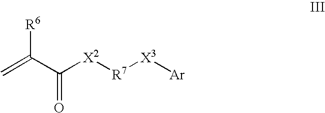
wherein R⁶ is hydrogen or methyl; X² and X³ are independently in each instance O or S; R⁷ is a divalent C₁-C₂₀ aliphatic radical, a divalent C₃-C₂₀ cycloaliphatic radical, or a divalent C₃-C₂₀ aromatic radical; Ar is monovalent C₃-C₂₀ aromatic radical.

### DETAILED DESCRIPTION

The terms “a” and “an” herein do not denote a limitation of quantity, but rather denote the presence of at least one of the referenced item. All ranges disclosed herein are inclusive and combinable.

While only certain features of the invention have been illustrated and described herein, many modifications and changes will occur to those skilled in the art. It is, therefore, to be understood that the appended claims are intended to cover all such modifications and changes as fall within the true spirit of the invention.

As used herein, the term “integer” refers to any whole number that is not zero. As used herein, the phrase “number ranging from” refers to any number within that range, inclusive of the limits, and could be both whole numbers and fractions.

As used herein the term “aliphatic radical” refers to a radical having a valence of at least one comprising a linear or branched array of atoms which is not cyclic. The array may include heteroatoms such as nitrogen, sulfur, silicon, selenium and oxygen or may be composed exclusively of carbon and hydrogen. Aliphatic radicals may be “substituted” or “unsubstituted”. A substituted aliphatic radical is defined as an aliphatic radical which comprises at least one substituent. A substituted aliphatic radical may comprise as many substituents as there are positions available on the aliphatic radical for substitution. Substituents which may be present on an aliphatic radical include but are not limited to halogen atoms such as fluorine, chlorine, bromine, and iodine. Substituted aliphatic radicals include trifluoromethyl, hexafluoroisopropylidene, chloromethyl; difluorovinylidene; trichloromethyl, bromoethyl, bromotrimethylene (e.g. —CH₂CHBrCH₂—), and the like. For convenience, the term “unsubstituted aliphatic radical” is defined herein to encompass, as part of the “linear or branched array of atoms which is not cyclic” comprising the unsubstituted aliphatic radical, a wide range of functional groups. Examples of unsubstituted aliphatic radicals include allyl, aminocarbonyl (i.e. —CONH₂), carbonyl, dicyanoisopropylidene (i.e. —CH₂C(CN)₂CH₂—), methyl (i.e. —CH₃), methylene (i.e. —CH₂—), ethyl, ethylene, formyl, hexyl, hexamethylene, hydroxymethyl (i.e. —CH₂OH), mercaptomethyl (i.e. —CH₂SH), methylthio (i.e. —SCH₃), methylthiomethyl (i.e. —CH₂SCH₃), methoxy, methoxycarbonyl (CH₃OCO), nitromethyl (i.e. —CH₂NO₂), thiocarbonyl, trimethylsilyl, t-butyldimethylsilyl, trimethyloxysilylpropyl, vinyl, vinylidene, and the like. Aliphatic radicals are defined to comprise at least one carbon atom. A C₁-C₁₀ aliphatic radical includes substituted aliphatic radicals and unsubstituted aliphatic radicals containing at least one but no more than 10 carbon atoms.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. Aromatic radicals may be “substituted” or “unsubstituted”. A substituted aromatic radical is defined as an aromatic radical which comprises at least one substituent. A substituted aromatic radical may comprise as many substituents as there are positions available on the aromatic radical for substitution. Substituents which may be present on an aromatic radical include, but are not limited to halogen atoms such as fluorine, chlorine, bromine, and iodine. Substituted aromatic radicals include trifluoromethylphenyl, hexafluoroisopropylidenebis(4-phenyloxy) (i.e. —OPhC(CF₃)₂PhO—), chloromethylphenyl; 3-trifluorovinyl-2-thienyl; 3-trichloromethylphenyl (i.e. 3-CCl₃Ph-), bromopropylphenyl (i.e. BrCH₂CH₂CH₂Ph-), and the like. For convenience, the term “unsubstituted aromatic radical” is defined herein to encompass, as part of the “array of atoms having a valence of at least one comprising at least one aromatic group”, a wide range of functional groups. Examples of unsubstituted aromatic radicals include 4-allyloxyphenoxy, aminophenyl (i.e. H₂NPh-), aminocarbonylphenyl (i.e. NH₂COPh-), 4-benzoylphenyl, dicyanoisopropylidenebis(4-phenyloxy) (i.e. —OPhC(CN)₂PhO—), 3-methylphenyl, methylenebis(4-phenyloxy) (i.e. —OPhCH₂PhO—), ethylphenyl, phenylethenyl, 3-formyl-2-thienyl, 2-hexyl-5-furanyl; hexamethylene-1,6-bis(4-phenyloxy) (i.e. —OPh(CH₂)₆PhO—); 4-hydroxymethylphenyl (i.e. 4-HOCH₂Ph-), 4-mercaptomethylphemyl (i.e. 4-HSCH₂Ph-), 4-methylthiophenyl (i.e. 4-CH₃SPh-), methoxyphenyl, methoxycarbonylphenyloxy (e.g. methyl salicyl), nitromethylphenyl (i.e. -PhCH₂NO₂), trimethylsilylphenyl, t-butyldimethylsilylphenyl, vinylphenyl, vinylidenebis(phenyl), and the like. The term “a C₃-C₁₀ aromatic radical” includes substituted aromatic radicals and unsubstituted aromatic radicals containing at least three but no more than 10 carbon atoms. The aromatic radical 1-imidazolyl (C₃H₂N₂—) represents a C₃ aromatic radical. The benzyl radical (C₇H₈—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is a cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. Cycloaliphatic radicals may be “substituted” or “unsubstituted”. A substituted cycloaliphatic radical is defined as a cycloaliphatic radical which comprises at least one substituent. A substituted cycloaliphatic radical may comprise as many substituents as there are positions available on the cycloaliphatic radical for substitution. Substituents which may be present on a cycloaliphatic radical include but are not limited to halogen atoms such as fluorine, chlorine, bromine, and iodine. Substituted cycloaliphatic radicals include trifluoromethylcyclohexyl, hexafluoroisopropylidenebis(4-cyclohexyloxy) (i.e. —OC₆H₁₀C(CF₃)₂C₆H₁₀O—), chloromethylcyclohexyl; 3-trifluorovinyl-2-cyclopropyl; 3-trichloromethylcyclohexyl (i.e. 3-CCl₃C₆H₁₀—), bromopropylcyclohexyl (i.e. BrCH₂CH₂CH₂C₆H₁₀—), and the like. For convenience, the term “unsubstituted cycloaliphatic radical” is defined herein to encompass a wide range of functional groups. Examples of unsubstituted cycloaliphatic radicals include 4-allyloxycyclohexyl, aminocyclohexyl (i.e. H₂N C₆H₁₀—), aminocarbonylcyclopentyl (i.e. NH₂COC₅H₈—), 4-acetyloxycyclohexyl, dicyanoisopropylidenebis(4-cyclohexyloxy) (i.e. —OC₆H₁₀C(CN)₂C₆H₁₀O—), 3-methylcyclohexyl, methylenebis(4-cyclohexyloxy) (i.e. —OC₆H₁₀CH₂C₆H₁₀O—), ethylcyclobutyl, cyclopropylethenyl, 3-formyl-2-terahydrofuranyl, 2-hexyl-5-tetrahydrofuranyl; hexamethylene-1,6-bis(4-cyclohexyloxy) (i.e. —OC₆H₁₀(CH₂)₆ C₆H₁₀O—); 4-hydroxymethylcyclohexyl (i.e. 4-HOCH₂C₆H₁₀—), 4-mercaptomethylcyclohexyl (i.e. 4-HSCH₂ C₆H₁₀—), 4-methylthiocyclohexyl (i.e. 4-CH₃S C₆H₁₀—), 4-methoxycyclohexyl, 2-methoxycarbonylcyclohexyloxy (2-CH₃OCO C₆H₁₀O—), nitromethylcyclohexyl (i.e. NO₂CH₂C₆H₁₀—), trimethylsilylcyclohexyl, t-butyldimethylsilylcyclopentyl, 4-trimethoxysilylethylcyclohexyl (e.g. (CH₃O)₃SiCH₂CH₂C₆H₁₀—), vinylcyclohexenyl, vinylidenebis(cyclohexyl), and the like. The term “a C₃-C₁₆ cycloaliphatic radical” includes substituted cycloaliphatic radicals and unsubstituted cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

The phrase “(meth)acrylate monomer” refers to any of the monomers comprising at least one acrylate unit, wherein the substitution of the double bonded carbon adjacent to the carbonyl group is either a hydrogen or a methyl substitution. Examples of “(meth)acylate monomers” include methyl methacrylate where the substitution on the double bonded carbon adjacent to the carbonyl group is a methyl group, acrylic acid where the substitution on the double bonded carbon adjacent to the carbonyl group is a hydrogen group, phenyl methacrylate where the substitution on the double bonded carbon adjacent to the carbonyl group is a methyl group, phenyl thioethyl methacrylate where the substitution on the double bonded carbon adjacent to the carbonyl group is a methyl group, ethyl acrylate where the substitution on the double bonded carbon adjacent to the carbonyl group is a hydrogen group 2,2-bis((4-methacryloxy)phenyl)propane where the substitution on the double bonded carbon adjacent to the carbonyl group is a methyl group, and the like.

This invention is related to a curable composition comprising at least one silicone containing surfactant and at least one methacrylate monomer.

In one aspect, the curable composition is a solvent-free, high refractive index, radiation curable composition that provides a cured material having an excellent balance of properties. The compositions are ideally suited for light management film applications. In one aspect, light management films prepared from the curable compositions exhibit good brightness.

The curable compositions comprise a multifunctional (meth)acrylate represented by the structure I 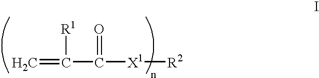
wherein R¹ is hydrogen or methyl; X¹ is O or S; n is 2; and R² is a divalent aromatic radical having structure II: 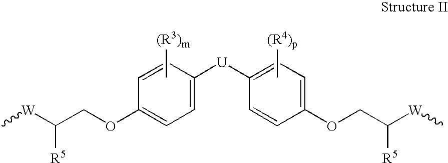
wherein U is a bond, an oxygen atom, a sulfur atom or a selenium atom, an SO₂ group, an SO group, a CO group, a C₁-C₂₀ aliphatic radical, C₃-C₂₀ cycloaliphatic radical, or a C₃-C₂₀ aromatic radical; R³ and R⁴ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; R⁵ is a hydrogen, or a hydroxyl, or a thiol, or an amino group, or a halogen group; W is a bond, or a divalent C₁-C₂₀ aliphatic radical, or a divalent C₃-C₂₀ cycloaliphatic radical, or a divalent C₃-C₂₀ aromatic radical; m and p are integers ranging from 0 to 4.

The multifunctional (meth)acrylates may include compounds produced by the reaction of acrylic or methacrylic acid with a di-epoxide, such as bisphenol-A diglycidyl ether; bisphenol-F diglycidyl ether; tetrabromo bisphenol-A diglycidyl ether; tetrabromo bisphenol-F diglycidyl ether; 1,3-bis-{4-[1-methyl-1-(4-oxiranylmethoxy-phenyl)-ethyl]-phenoxy}-propan-2-ol; 1,3-bis-{2,6-dibromo-4-[1-(3,5-dibromo-4-oxiranylmethoxy-phenyl)-1-methyl-ethyl]-phenoxy}-propan-2-ol; and the like; and a combination comprising at least one of the foregoing di-epoxides. Examples of such compounds include 2,2-bis(4-(2-(meth)acryloxyethoxy)phenyl)propane; 2,2-bis((4-(meth)acryloxy)phenyl)propane; acrylic acid 3-(4-{1-[4-(3-acryloyloxy-2-hydroxy-propoxy)-3,5,-dibromo-phenyl]-1-methyl-ethyl}-2,6-dibromo-phenoxy)-2-hydroxy-propyl ester; acrylic acid 3-[4-(1-{4-[3-(4-{1-[4-(3-acryloyloxy-2-hydroxy-propoxy)-3,5-dibromo-phenyl]-1-methyl-ethyl}-2,6-dibromo-phenoxy)-2-hydroxy-propoxy]-3,5-dibromo-phenyl}-1-methyl-ethyl)-2,6-dibromo-phenoxy]-2-hydroxy-propyl ester; and the like, and a combination comprising at least one of the foregoing multifunctional (meth)acrylates. A suitable multifunctional acrylate based on the reaction product of tetrabrominated bisphenol-A di-epoxide is RDX 51027 available from UCB Chemicals. Other commercially available multifunctional acrylates include EB600, EB3600, EB3605, EB3700, EB3701, EB3702, EB3703, and EB3720, all available from UCB Chemicals, or CN104 and CN120 available from Sartomer.

The curable composition further comprises a substituted or unsubstituted arylether (meth)acrylate monomer. A preferred substituted or unsubstituted arylether (meth)acrylate monomer is represented by the formula (III) 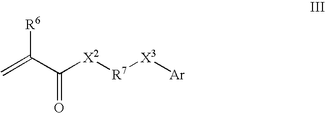
wherein R⁶ is hydrogen or methyl; X² and X³ are independently in each instance O or S; R⁷ is a divalent C₁-C₂₀ aliphatic radical, a divalent C₃-C₂₀ cycloaliphatic radical, or a divalent C₃-C₂₀ aromatic radical; Ar is monovalent C₃-C₂₀ aromatic radical. As used herein, “arylether” is inclusive of both arylethers and arylthioethers, also known as arylsulfides, unless otherwise indicated. Particularly preferred substituted or unsubstituted arylether (meth)acrylate monomers are selected from the group consisting of 2-phenoxyethyl acrylate and 2-phenylthioethyl acrylate, and mixtures thereof.

The multifunctional (meth)acrylate is present in the curable composition in an amount of about 30 to about 80 weight percent based on the total composition. Within this range, an amount of greater than or equal to about 35 weight percent may be used, with greater than or equal to about 45 weight percent preferred, and greater than or equal to about 50 weight percent more preferred. Also within this range, an amount of less than or equal to about 75 weight percent may be used, with less than or equal to about 70 weight percent preferred, and less than or equal to about 65 weight percent more preferred.

The substituted or unsubstituted arylether (meth)acrylate monomer is present in the curable composition in an amount of about 20 to about 50 weight percent based on the total composition. Within this range, it may be preferred to use an amount of greater than or equal to about 20 weight percent, more preferably greater than or equal to about 30 weight percent.

The composition further comprises a polymerization initiator to promote polymerization of the (meth)acrylate components. Suitable polymerization initiators include photoinitiators that promote polymerization of the components upon exposure to ultraviolet radiation. Particularly suitable photoinitiators include phosphine oxide photoinitiators. Examples of such photoinitiators include the IRGACURE® and DAROCUR™ series of phosphine oxide photoinitiators available from Ciba Specialty Chemicals; the LUCIRIN® series from BASF Corp.; and the ESACURE® series of photoinitiators. Other useful photoinitiators include ketone-based photoinitiators, such as hydroxy- and alkoxyalkyl phenyl ketones, and thioalkylphenyl morpholinoalkyl ketones. Also suitable are benzoin ether photoinitiators.

The polymerization initiator may include peroxy-based initiators that may promote polymerization under thermal activation. Examples of useful peroxy initiators include, for example, benzoyl peroxide, dicumyl peroxide, methyl ethyl ketone peroxide, lauryl peroxide, cyclohexanone peroxide, t-butyl hydroperoxide, t-butyl benzene hydroperoxide, t-butyl peroctoate, 2,5-dimethylhexane-2,5-dihydroperoxide, 2,5-dimethyl-2,5-di(t-butylperoxy)-hex-3-yne, di-t-butylperoxide, t-butylcumyl peroxide, alpha,alpha′-bis(t-butylperoxy-m-isopropyl)benzene, 2,5-dimethyl-2,5-di(t-butylperoxy)hexane, dicumylperoxide, di(t-butylperoxy isophthalate, t-butylperoxybenzoate, 2,2-bis(t-butylperoxy)butane, 2,2-bis(t-butylperoxy)octane, 2,5-dimethyl-2,5-di(benzoylperoxy)hexane, di(trimethylsilyl)peroxide, trimethylsilylphenyltriphenylsilyl peroxide, and the like, and combinations comprising at least one of the foregoing polymerization initiators.

The polymerization initiator may be used in an amount of about 0.01 to about 10 weight percent based on the total weight of the composition. Within this range, it may be preferred to use a polymerization initiator amount of greater than or equal to about 0.1 weight percent, more preferably greater than or equal to about 0.5 weight percent. Also within this range, it may be preferred to use a polymerization initiator amount of less than or equal to about 5 weight percent, more preferably less than or equal to about 3 weight percent.

The curable coating compositions of the invention further comprise low levels of at least one silicone-containing surfactant, for example a polyalkyleneoxide modified polydimethyl siloxane, said curable coating compositions have been surprisingly found to exhibit exceptional mold release properties upon curing. The preparation of polyalkyleneoxide modified polydimethyl siloxanes is well known in the art. Polyalkyleneoxide modified polydimethyl siloxanes of the present invention can be prepared according to the procedure set forth in U.S. Pat. No. 3,299,112. These and other surfactants suitable for use are well known in the art, being described in more detail in Kirk Othmer's Encyclopedia of Chemical Technology, 4th Ed., Vol. 22, pp. 82-142, “Surfactants and Detersive Systems.” Further suitable nonionic detergent surfactants are generally disclosed in U.S. Pat. No. 3,929,678, Laughlin et al., issued Dec. 30, 1975, at column 13, line 14 through column 16, line 6.

In a preferred embodiment of the invention, a polyalkyleneoxide modified polydimethyl siloxane represented by structure IV is used. 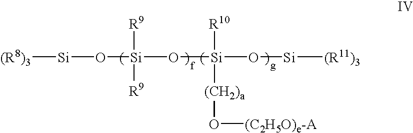
wherein R⁸, R⁹, R¹⁰, and R¹¹ maybe independently in each instance a C₁-C₂₀ aliphatic radicals; A is a hydrogen or a monovalent aliphatic radical; a and e are integers ranging from 1 to 20 independently in each instance; f and g are numbers ranging from 1 to 50 independently in each instance.

Dramatic improvements in mold release performance have been achieved by inclusion in the curable coating composition of a relatively small amount, in one embodiment from about 0.01 to about 5 percent by weight, in another embodiment from about 0.1 to about 1 percent by weight, and in yet another embodiment from about 0.1 to about 0.5 pecent by weight of the curable composition, of a silicone-containing surfactant. Because silicone-containing surfactants are highly effective at low concentrations relative to the concentrations needed with conventional mold release agents, the silicone-containing surfactants typically do not negatively affect the physical properties (Refractive Index, Glass Transition Temperature, and the like) of the cured optical films as do conventional mold release agents at higher concentrations. Silicone-containing surfactants are widely available commercially and typically comprise compositions comprising hydrophilic polyether substructures and hydrophobic silicon-containing substructures. SILWET 7602 and SILWET 720 are preferred silicone-containing surfactants and are available from OSi Specialty Chemicals, Ltd. Other suitable siloxane surfactants include, but are not limited to SILWET L-7608, SILWET L-7607, SILWET L-77, SILWET L-7605, SILWET L-7604, SILWET L-7600, SILWET L-7657 and combinations thereof. The molecular weight of the polyalkyleneoxy group is typically less than or equal to about 10,000. Preferably, the molecular weight of the polyalkyleneoxy group is less than or equal to about 8,000, and most preferably ranges from about 300 to about 5,000. If propyleneoxy groups are present in the polyalkylenoxy chain, they can be distributed randomly in the chain or exist as blocks. Preferred SILWET surfactants are SILWET L-7600, SILWET L-7602, SILWET L-7604, SILWET L-7605, SILWET L-7657, and mixtures thereof.

Other preferred silicone-containing surfactants are available from BYK-Chemie (for example, BYK-300 and BYK-301), Dow Corning (For example, Additive 11 and Additive 57), and Efka (for example, Efka 3236, Efka 3239, Efka 3299 & Efka 3232).

The composition may, optionally, further comprise an additive selected from flame retardants, antioxidants, thermal stabilizers, ultraviolet stabilizers, dyes, colorants, anti-static agents, and the like, and a combination comprising at least one of the foregoing additives, so long as they do not deleteriously affect the polymerization of the composition.

The compositions provided herein comprising a substituted or unsubstituted arylthioether (meth)acrylate monomer, a multifunctional (meth)acrylate, and a polymerization initiator provide materials having excellent refractive indices without the need for the addition of known high refractive index additives. Such compositions, when cured into microstructured films, provide films exhibiting excellent brightness.

The curable composition may be prepared by simply blending the components thereof, with efficient mixing to produce a homogeneous mixture. When forming articles from the curable composition, it is often preferred to remove air bubbles by application of vacuum or the like, with gentle heating if the mixture is viscous. The composition can then be charged to a mold that may bear a microstructure to be replicated and polymerized by exposure to ultraviolet radiation or heat to produce a cured article.

An alternative method includes applying the radiation curable, uncured, composition to a surface of a base film substrate, passing the base film substrate having the uncured composition coating through a compression nip defined by a nip roll and a casting drum having a negative pattern master of the microstructures. The compression nip applies a sufficient pressure to the uncured composition and the base film substrate to control the thickness of the composition coating and to press the composition into full dual contact with both the base film substrate and the casting drum to exclude any air between the composition and the drum. The base film substrate can be made of any material that can provide a sufficient backing for the uncured composition such as for example polymethyl methacrylate (i.e., PLEXIGLASS™), polyester (e.g. MYLAR™), polycarbonate (such as LEXAN™), polyvinyl chloride (VELBEX®), or even paper. In a preferred embodiment, the base film substrate comprises a polycarbonate-based material.

The radiation curable composition is cured by directing radiation energy through the base film substrate from the surface opposite the surface having the composition coating while the composition is in full contact with the drum to cause the microstructured pattern to be replicated in the cured composition layer. This process is particularly suited for continuous preparation of a cured composition in combination with a substrate.

The curable compositions are preferably cured by UV radiation. The wavelength of the UV radiation may be from about 1800 angstroms to about 4000 angstroms. Suitable wavelengths of UV radiation include, for example, UVA, UVB, UVC, UVV, and the like; the wavelengths of the foregoing are well known in the art. The lamp systems used to generate such radiation include ultraviolet lamps and discharge lamps, as for example, xenon, metallic halide, metallic arc, low or high pressure mercury vapor discharge lamp, etc. Curing is meant both polymerization and cross-linking to form a non-tacky material.

When heat curing is used, the temperature selected may be about 80° to about 130° C. Within this range, a temperature of greater than or equal to about 90° C. may be preferred. Also within this range, a temperature of greater than or equal to about 100° C. may be preferred. The heating period may be of about 30 seconds to about 24 hours. Within this range, it may be preferred to use a heating time of greater than or equal to about 1 minute, more preferably greater than or equal to about 2 minutes. Also within this range, it may be preferred to use a heating time of less than or equal to about 10 hours, more preferably less than or equal to about 5 hours, yet more preferably less than or equal to about 3 hours. Such curing may be staged to produce a partially cured and often tack-free composition, which then is fully cured by heating for longer periods or temperatures within the aforementioned ranges. In one embodiment, the composition may be both heat cured and UV cured.

In one embodiment, the composition is subjected to a continuous process to prepare a cured film material in combination with a substrate. To achieve the rapid production of cured material using a continuous process, the composition preferably cures in a short amount of time.

Current manufacturing processes for the low cost production of cured films require rapid and efficient curing of materials followed by easy release of the cured film from the mold. The compositions comprising a silicone containing surfactant, substituted or unsubstituted arylthioether (meth)acrylate monomer, a multifunctional (meth)acrylate, especially those corresponding to formulas (I) and (III), and an optional polymerization initiator have been found to efficiently cure under typical conditions employed for the rapid, continuous production of cured, coated films employing UV irradiation. Such compositions exhibit excellent relative degree of cure under a variety of processing conditions.

In one embodiment, a curable composition comprises about 80 to about 20 weight percent of a multifunctional (meth)acrylate; about 20 to about 80 weight percent of a substituted or unsubstituted arylether (meth)acrylate monomer; and about 0.1 to about 2 weight percent of a phosphine oxide photoinitiator.

Other embodiments include articles made from any of the cured compositions. Articles that may be fabricated from the compositions include, for example, optical articles, such as light management films for use in back-light displays; projection displays; traffic signals; illuminated signs; optical lenses; Fresnel lenses; optical disks; diffuser films; holographic substrates; or as substrates in combination with conventional lenses, prisms or mirrors. The invention is further illustrated by the following non-limiting examples.

### EXAMPLES

The formulations for the following Examples were prepared from the components listed in Table 1.

TABLE 1

| Component | Trade Name | Description | Source |
|---|---|---|---|
| RDX51027 (“RDX”) | RDX51027 | Diacrylate of tetrabromo | UCB Chemicals |
| | | bisphenol-A di-epoxide | |
| PTEA | BX-PTEA | Phenylthioethyl acrylate | Bimax Company |
| PEA | SR339 | 2-Phenoxyethyl acrylate | Sartomer |
| Irgacure | Irgacure 819 | Bis(2,4,6- | Ciba-Geigy |
| | | trimethylbenzoyl)- | |
| | | phenylphosphine oxide | |
| Darocur | Darocur 4265 | 2-Hydroxy-2-methyl-1- | Ciba Specialty Chemicals |
| | | phenyl-propan-1-one and | |
| | | Bis(2,4,6- | |
| | | trimethylbenzoyl)- | |
| | | phenylphosphine oxide | |
| HDDA | SR238 | Hexanediol Diacrylate | Sartomer |
| BDDA | SR213 | Butanediol Diacrylate | Sartomer |
| Polyether modified | BYK301 | Polyether modified | BYK-Chemie |
| dimethylpolysiloxane- | | dimethylpolysiloxane- | |
| copolymer | | copolymer | |
| Polyether modified | Silwet L7602 | Polyether modified | OSi Specialty Chemicals, Ltd |
| dimethylpolysiloxane- | | dimethylpolysiloxane- | |
| copolymer | | copolymer | |
| Polyether modified | Silwet L720 | Polyether modified | OSi Specialty Chemicals, Ltd |
| dimethylpolysiloxane- | | dimethylpolysiloxane- | |
| copolymer | | copolymer | |
| Polycarbonate | Lexan | Optical Quality Film | GE Advanced Materials |

A laminating process was used to coat polycarbonate film. The laminating unit consisted of two rubber rolls: a bottom variable speed drive roll and a pneumatically driven top nip roll. This system was used to press together laminate stacks that are passed between the rolls. Coated films were prepared by placing approximately 5 mL of liquid coating at the front or leading edge of an 11″×12″ electroformed tool held in place on a steel plate by 3M™ FLEXO mounting tape. A piece of polycarbonate film was then placed over the electroformed tool with the liquid coating and the resulting stack sent through the laminating unit to press and distribute the photopolymerizable liquid uniformly between the electroformed tool and polycarbonate substrate. Photopolymerization of the coating within the stack was accomplished using a Fusion EPIC 6000UV curing system by passing the stack under a 600-watt V-bulb.

After curing, the coated polycarbonate film was removed from the electroformed tool by peeling away. This was accomplished by lifting the film away from the electroformed tool at approximately a 45-90 degree angle. When no surfactant was used, considerable force was required to peel the coated film from the electroformed tool, i.e. molding tool, whereas less force was required when the proper release additive was used. The effort or force required to remove the coated film from the tool was assessed and used to develop a Mold Release Score as described in Table 2. Typically, the problems with the nature of the release include buckling or curling of the film after release, phase separation of components, delamination of the coated film from the plastic backing, adhesion to the plastic backing. The coated cured flat film was then peeled off of the flat tool and used for abrasion, % haze, % transmission, color, yellowness index, and adhesion measurements.

Coated cured microstructured films for measuring luminance were made in the same manner as coated cured flat films by substituting the highly polished flat steel plate for an electroformed tool with a prismatic geometry. The geometry of the prisms can be found in FIG. 6 of the copending U.S. application Ser. No. 10/065,981 entitled “Brightness Enhancement Film With Improved View Angle” filed Dec. 6, 2002, which is incorporated by reference herein in its entirety. Table 2.

TABLE 2

| | | Tool | Cure | Strip | Tool | □ |
|---|---|---|---|---|---|---|
| | | Temp | Temp | Temp | Release | Lumi- |
| Ser. No. | Formulation | (F.) | (F.) | (F.) | Score * | nance |
| Comparative | 60% RDX/ | 104 | 107 | 104 | ++++ | (−)3% |
| Example. 1 | 30% PTEA/ | | | | | |
| | 10% HDDA | | | | | |
| Example 1 | 59.5% RDX/ | 104 | 111 | 102 | ++++ | − |
| | 39.5% PTEA/ | | | | | |
| | 1% SILWET | | | | | |
| | L720 | | | | | |
| Example 2 | 59.75% RDX/ | 103 | 104 | 104 | +++ | (−)1% |
| | 39.75% PTEA/ | | | | | |
| | 0.5% SILWET | | | | | |
| | L7602 | | | | | |
| Example 3 | 59.9% RDX/ | 106 | 109 | 106 | +++ | (−)1% |
| | 39.9% PTEA/ | | | | | |
| | 0.2% SILWET | | | | | |
| | L720 | | | | | |
| Comparative | 60% RDX/ | 106 | 109 | 102 | ++ | (−)2% |
| Example 2 | 35% PTEA/ | | | | | |
| | 5% HDDA | | | | | |
| Comparative | 60% RDX/ | 106 | 109 | 104 | + | (−)2% |
| Example 3 | 35% PTEA/ | | | | | |
| | 5% 1,4-BDDA | | | | | |
| Comprative | 60% RDX/ | 106 | 109 | 102 | + | |
| Example 4 | 37.5% PTEA/ | | | | | |
| | 2.5% HDDA | | | | | |
| Comparative | 60% RDX/ | 106 | 108 | 102 | + | |
| Example 5 | 35% PTEA/ | | | | | |
| | 2.5% 1,4-BDDA | | | | | |
| Example 4 | 59.95% RDX/ | 105 | 105 | 104 | + | |
| | 39.95% PTEA/ | | | | | |
| | 0.1% SILWET | | | | | |
| | L7602 | | | | | |
| Example 5) | 59.9% RDX/ | 95 | 108 | 95 | + | |
| | 39.9% PTEA/ | | | | | |
| | 0.2% SILWET | | | | | |
| | L720 | | | | | |
| Example 6 | 59.95% RDX/ | 105 | 104 | 104 | + | |
| | 39.95% PTEA/ | | | | | |
| | 0.1% SILWET | | | | | |
| | L720 | | | | | |
| Example 7 | 60% RDX/ | 104 | 105 | 102 | − | |
| | 40% PTEA/ | | | | | |
| | 0.3% BYK301 | | | | | |
| Comparative | 60% RDX/ | 106 | 105 | 99 | − | |
| Example 7 | 40% PTEA | | | | | |
| Comparative | 60% RDX/ | 95 | 95 | 93 | − | |
| Example 8 | 30% PTEA/ | | | | | |
| | 10% HDDA | | | | | |
| Comparative | 60% RDX/ | 81 | 88 | 86 | −− | |
| Example 9 | 40% PTEA | | | | | |
| Comparative | 60% RDX/ | 73 | 82 | 80 | −−− | |
| Example 10 | 40% PTEA | | | | | |

* The tool release score is a measure of the release of the film from the tool and is a combination of multiple characteristics such as release, buckling of the film, adhesion to the substrate, and luminance.
++++ represents excellent release and excellent film characteristics
+++ represents excellent release and good film characteristics
++ represents good release and good film characteristics
+ represents average release and average film characteristics
− represents a weakness in either the release or the film characteristics
−− represents poor release and poor film characteristics
−−− represents very poor release and very poor film characteristics

Data in table 2 showed that those compositions comprising the silicone-containing surfactants, even in concentrations as low as 0.1% by weight to 1% by weight, possess better release characteristics as compared to the compositions that do not contain the surfactants. There was reduced delamination between the coating and polymer substrate, better adhesion between the two layers, and excellent release for those compositions comprising the silicone-containing surfactant. These examples show the surprising discovery of the effect of silicone-containing surfactants at low concentrations on the coating compositions. While the data in Table 2 also show that HDDA was effective for providing acceptable tool release characteristics, its use was accompanied by an unacceptably high loss of luminance.

The invention has been described in detail with particular reference to preferred embodiments thereof, but it will be understood by those skilled in the art that variations and modifications can be effected within the spirit and scope of the invention.

1. A curable composition, comprising:
(a) at least one silicone containing surfactant, wherein the surfactant is present in a range corresponding to from about 0.01 to about 5 weight percent based upon the total weight of the composition;
(b) a multifunctional (meth)acrylate represented by the structure I 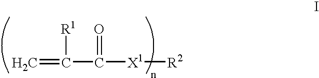
wherein R¹ is hydrogen or methyl; X¹ is O or S; n is 2; and R² is a divalent aromatic radical having structure II: 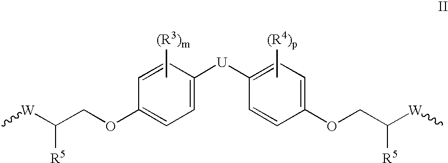
wherein U is a bond, an oxygen atom, a sulfur atom or a selenium atom, an SO₂ group, an SO group, a CO group, a C₁-C₂₀ aliphatic radical, C₃-C₂₀ cycloaliphatic radical, or a C₃-C₂₀ aromatic radical; R³ and R⁴ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; R⁵ is a hydrogen, or a hydroxyl, or a thiol, or an amino group, or a halogen group; W is a bond, or a divalent C₁-C₂₀ aliphatic radical, or a divalent C₃-C₂₀ cycloaliphatic radical, or a divalent C₃-C₂₀ aromatic radical; m and p are integers ranging from 0 to 4; and
(c) an arylether (meth)acrylate monomer having structure III 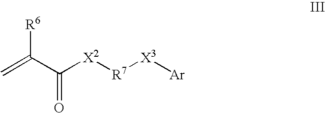
wherein R⁶ is hydrogen or methyl; X² and X³ are independently in each instance O or S; R⁷ is a divalent C₁-C₂₀ aliphatic radical, a divalent C₃-C₂₀ cycloaliphatic radical, or a divalent C₃-C₂₀ aromatic radical; Ar is monovalent C₃-C₂₀ aromatic radical.

2. The curable composition according to claim 1, wherein said surfactant is a polyalkyleneoxide modified polydimethylsiloxane.

3. The curable composition according to claim 2, wherein said surfactant is a polyalkyleneoxide modified polydimethylsiloxane of structure (IV) 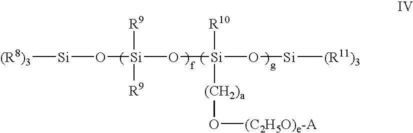
wherein R⁸, R⁹, R¹⁰, and R¹¹ maybe independently in each instance a C₁-C₂₀ aliphatic radicals; A is a hydrogen or a monovalent aliphatic radical; a and e are integers ranging from 1 to 20 independently in each instance; f and g are numbers ranging from 1 to 50 independently in each instance. The curable composition according to claim 2, wherein U is selected from the group consisting of —C(CH₃)₂—, —CH₂—, —CO—, —SO—, or —SO₂—.

4. The curable composition according to claim 1, wherein the multifunctional (meth)acrylate has structure VI 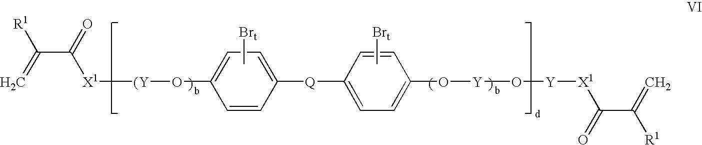
wherein R¹ is hydrogen or methyl; X¹ is O or S; Q is —C(CH₃)₂—, —CH₂—, —C(O)—, —S(O)—, or —S(O)₂—; Y is independently at each occurrence a C₁-C₆ aliphatic radical; b is independently at each occurrence a number from 1 to about 10; t is independently at each occurrence a number from 1 to about 4; and d is a number from 1 to about 10.

5. The curable composition according to claim 1, wherein said composition has a total weight, and wherein the surfactant is present in an amount corresponding to from about 0.1 to about 1 weight percent based upon the total weight of the composition.

6. The curable composition according to claim 6, wherein the surfactant is present in an amount corresponding to from about 0.1 to about 0.5 weight percent based upon the total weight of the composition.

7. The curable composition according to claim 6 wherein compound I is present in an amount corresponding to from about 50% to about 80% by weight, and compound III is present in an amount corresponding to from about 20% to about 50% by weight, based upon the total weight of the composition.

8. A cured acrylate composition, comprising:
(a) at least one silicone containing surfactant, wherein the surfactant is present in a range corresponding to from about 0.01 to about 5 weight percent based upon the total weight of the composition; and
structural units derived from
(b) a multifunctional (meth)acrylate represented by the structure I 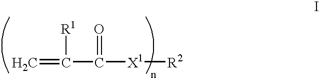
wherein R¹ is hydrogen or methyl; X¹ is O or S; n is 2; and R² is a divalent aromatic radical having structure II: 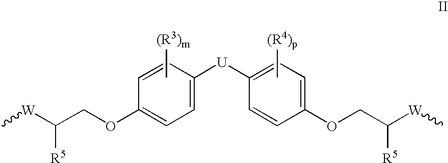
wherein U is a bond, an oxygen atom, a sulfur atom or a selenium atom, an SO₂ group, an SO group, a CO group, a C₁-C₂₀ aliphatic radical, C₃-C₂₀ cycloaliphatic radical, or a C₃-C₂₀ aromatic radical; R³ and R⁴ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; R⁷ is a hydrogen, or a hydroxyl, or a thiol, or an amino group, or a halogen group; W is a bond, or a divalent C₁-C₂₀ aliphatic radical, or a divalent C₃-C₂₀ cycloaliphatic radical, or a divalent C₃-C₂₀ aromatic radical; m and p are integers ranging from 0 to 4; and
(c) an arylether (meth)acrylate monomer having structure III 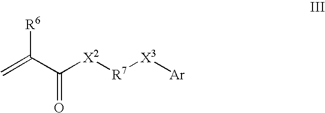
wherein R⁵ is hydrogen or methyl; X² and X³ are independently in each instance O or S; R⁶ is a divalent C₁-C₂₀ aliphatic radical, a divalent C₃-C₂₀ cycloaliphatic radical, or a divalent C₃-C₂₀ aromatic radical; Ar is monovalent C₃-C₂₀ aromatic radical.

9. The cured acrylate composition according to claim 9, wherein said surfactant is a polyalkyleneoxide modified polydimethylsiloxane

10. The cured composition according to claim 10, wherein said surfactant is a polyalkyleneoxide modified polydimethylsiloxane of structure (IV) 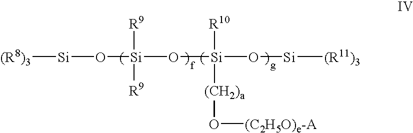
wherein R⁸, R⁹, R¹⁰, and R¹¹ maybe independently in each instance a C₁-C₂₀ aliphatic radicals; A is a hydrogen or a monovalent aliphatic radical; a and e are integers ranging from 1 to 20 independently in each instance; f and g are numbers ranging from 1 to 50 independently in each instance.

11. The cured composition according to claim 9, wherein the multifunctional (meth)acrylate has structure has structure VI 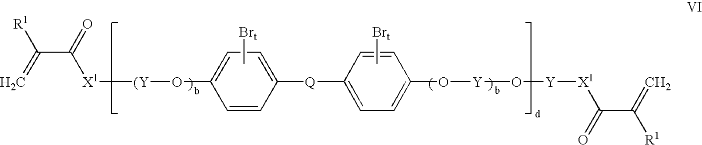
wherein R¹ is hydrogen or methyl; X¹ is O or S; Q is —C(CH₃)₂—, —CH₂—, —C(O)—, —S(O)—, or —S(O)₂—; Y is independently at each occurrence a C₁-C₆ aliphatic radical; b is independently at each occurrence a number from 1 to about 10; t is independently at each occurrence a number from 1 to about 4; and d is a number from 1 to about 10.

12. The cured acrylate composition according to claim 9, wherein said composition has a total weight, and wherein the surfactant is present in an amount corresponding to from about 0.01 to about 1 weight percent based upon the total weight of the composition.

13. The cured acrylate composition according to claim 9, wherein the surfactant is present in an amount corresponding to from about 0.1 to about 0.5 weight percent based upon the total weight of the composition.

14. A curable composition, consisting essentially of:
(a) at least one silicone containing surfactant, wherein the surfactant is present in a range corresponding to from about 0.01 to about 5 weight percent based upon the total weight of the composition;
(b) a multifunctional (meth)acrylate represented by the structure I 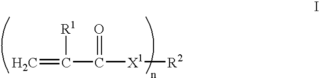
wherein R¹ is hydrogen or methyl; X¹ is O or S; n is 2; and R² is a divalent aromatic radical having structure VII: 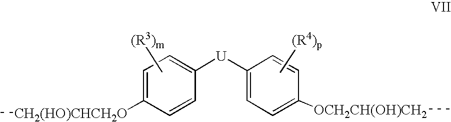
wherein Q is a bond, an oxygen atom, a sulfur atom or a selenium atom, an SO₂ group, an SO group, a C₁-C₂₀ aliphatic radical, C₃-C₂₀ cycloaliphatic radical, or a C₃-C₂₀ aromatic radical; R³ and R⁴ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; m and p are integers ranging from o to 4; and
(c) an arylether (meth)acrylate monomer having structure III 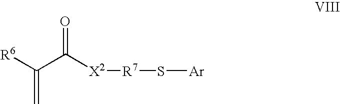
wherein R⁵ is hydrogen or methyl; X² is O or S; R⁶ is a divalent C₁-C₂₀ aliphatic radical, a divalent C₃-C₂₀ cycloaliphatic radical, or a a divalent C₃-C₂₀ aromatic radical; Ar is monovalent C₃-C₂₀ aromatic radical.

15. An article comprising a cured acrylate composition, said composition comprising
(a) at least one silicone-containing surfactant, wherein the surfactant is present in a range corresponding to from about 0.01 to about 5 weight percent based upon the total weight of the composition; and
structural units derived from
(b) a multifunctional (meth)acrylate represented by the structure I 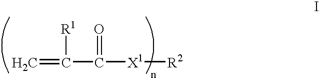
wherein R¹ is hydrogen or methyl; X¹ is O or S; n is 2; and R² is a divalent aromatic radical having structure II: 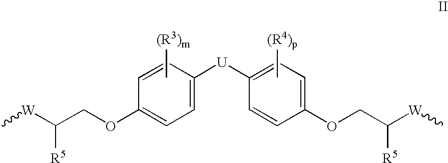
wherein U is a bond, an oxygen atom, a sulfur atom or a selenium atom, an SO₂ group, an SO group, a C₁-C₂₀ aliphatic radical, C₃-C₂₀ cycloaliphatic radical, or a C₃-C₂₀ aromatic radical; R³ and R⁴ are independently selected from the group consisting of halogen, nitro, cyano, amino, hydroxyl, C₁-C₂₀ aliphatic radical, C₃-C₂₀ cycloaliphatic radical, or a C₃-C₂₀ aromatic radical; R⁷ is a hydrogen, or a hydroxyl, or a thiol, or an amino group, or a halogen group; W is a bond, or a divalent C₁-C₂₀ aliphatic radical, or a divalent C₃-C₂₀ cycloaliphatic radical, or a divalent C₃-C₂₀ aromatic radical; m and p are integers ranging from 0 to 4; and
(c) an arylether (meth)acrylate monomer having structure III 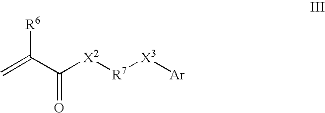
wherein R⁵ is hydrogen or methyl; X² and X³ are independently in each instance O or S; R⁶ is a divalent C₁-C₂₀ aliphatic radical, a divalent C₃-C₂₀ cycloaliphatic radical, or a divalent C₃-C₂₀ aromatic radical; Ar is monovalent C₃-C₂₀ aromatic radical.

16. The article according to claim 16 which is an optical film.

17. The article according to claim 16, said article comprising at least one surface microstructure.

18. The optical film according to claim 17, said article comprising at least one surface microstructure.

19. The article according to claim 17, said article being a multilayer article comprising a substrate selected from the group consisting of glass, and thermoplastic materials.

20. The article according to claim 20 wherein said article comprises at least one surface microstructure.

21. The article according to claim 20 wherein said substrate is a thermoplastic material.

22. An article according to claim 22 wherein said substrate is polycarbonate or a polyester such as polyethylene terephthalate.
